(19) United States
(12) Patent Application Publication
(10) Pub. No.: US 2006/0089790 A1
(43) Pub. Date: Apr. 27, 2006

(54) Vehicle locating device

(76) Inventor: Richard A Dupuis, Ontario (CA)

Correspondence Address: BAKER & DANIELS LLP;111 E. WAYNE STREET, SUITE 800, FORT WAYNE, IN, 46802, US

(21) Appl. No.: 10/519,253

(22) PCT Filed: Jun. 26, 2003
(86) PCT No.: PCT/CA03/00912

§ 371 Date: Oct. 11, 2005

(30) Foreign Application Priority Data
Jun. 21, 2002 (CA) 2,391,151

(51) Int. Cl. G01C 21/26

(52) U.S. Cl. 701/207

(57) ABSTRACT

A method of determining the location and status of a subject upon the occurrence of a trigger event comprises activating a sensor to a predetermined level corresponding to a class of event upon the occurrence of an event. An event signal is then transmitted to a central station indicating the class of event. Acknowledgement of receipt of signal is monitored and either acknowledgement of receipt signal is noted, or the event signal is retransmitted. Upon receipt of the acknowledgement signal, monitor mode is entered.

The present invention relates to a Vehicle Locating Device (VLD), that when installed and set up in a vehicle, boat, snowmobile, etc, has the capability of electronically determining and reporting its geographical position (fix) and current status. The position fix is determined using the Global Positioning System (GPS). Additionally, there is the optional capability of the unit determining a Dead Reckoning (DR) position that compliments the GPS. This is in case the GPS receiver module cannot establish a fix because the receiver's “view” of the satellites are obstructed. The reporting function is preferably via a separate telecommunications transceiver (modem).

The main role of the system is that a Passive Vehicle Locating (PVL) Device and the additional role being a Passive Collision Notification (PCN) device.

A reporting station may receive and collect this data and notify the appropriate services if it determines if the vehicle has been involved in an accident or meets criteria indicating it has been stolen.

Every year in Canada about 3,000 people lose their lives in automobile collisions. About half of these casualties and a further 40,000 Injuries occur in rural areas.¹ In the United States statistics show that about half the road accident casualties die at the scene of the accident. Of the remaining, many die because they arrive at a hospital too late to be saved. Response time and transport to a hospital of the crash victim is a primary factor when considering the survival of the victim.

Locating and recovering a distressed vehicle is an obviously important factor in saving accident victims' lives and property. The ability to shave minutes or seconds off the response time to an automobile accident is crucial when lives are in jeopardy. In some remote locations such as rural roads, a car accident may not be noticed until another person or automobile happens along. This could be hours or even days if for example an overturned car was off the road, buried in snow. This would also be particularly true if all the drivers and passengers were rendered unconscious by the impact, and or trapped inside wreckage.

A method of independently and instantly sending out a distress signal indicating the vehicles geographical location (fix) to emergency response authorities will cut down on the delay time between the accident event and emergency services arrival.

There have been systems developed, such as those shown in prior U.S. Pat. Nos. 5,914,675; 5,777,675; 5,418,537; 5,389,934; 5,317,323; 5,422,813; Re 35,920; 5,673,305; and 5,225,842 that have attempted to address the needs, with varying levels of success. None have succeeded in integrating solutions into a single package, however, and therefore a need exists, that is fulfilled by the present invention, for an improved and comprehensive vehicle locating device.

To eliminate the delay between an accident event and the communication to the emergency services, Automatic Collision Notification (ACN) systems have been developed as part of the present invention. By automatically transmitting a vehicle's telemetry in the event of a collision, the emergency response may be initiated immediately. The response team may therefore be dispatched directly to the location of the event with, in some systems, information about the severity of the event.

The transmission of a vehicle's fix may also be utilised in locating vehicles that have been stolen or high jacked. A dramatic increase in vehicle theft (automobiles, snowmobiles, boats, aeroplanes, etc.), for vehicle or parts resale has lead to an increase in demand by owners, police and insurance carriers for a measure to track and recover the stolen property.

By means of appropriate radio frequency (RF) technology systems and a small system controller in the vehicle a watchful eye can be kept on the ones' property through a monitoring service centre. Although it is not the design intent of the system to prevent the theft of the vehicle, measures can be built into the system to prevent the vehicle from starting when possible. The system may communicate the vehicle's location and particulars to the monitoring service at the request of the monitoring service or when triggered by the in-vehicle system. The monitoring service can then notify the appropriate authorities.

The system operates in a total passive mode to the user. That is, once the system is properly installed and commissioned, there are no further actions the owner must perform to ensure normal operation of the system. A user must however subscribe to a monitoring service contract. Then, if the owner does become aware of the theft of his vehicle, this must be reported to the monitoring service provider and police. It is probable that in this case, the vehicle will have already reported automatically and the owner is informed by the monitoring service.

The function of the VLD is to transmit accurate telemetry of a vehicle when either polled from a monitoring station or when the system detects vehicular involvement in a collision or break in.

The primary objective of the system is to significantly reduce the time in locating vehicles either for accident rescue purposes or commercial and enforcement service requirements.

The utility of the VLD system is in reducing morbidity and mortality from crashes, and reduce insurance claims due to auto theft. It is to also in crease efficiencies in commercial services and effectiveness of enforcement services.

The system of the present invention continuously derives position from the GPS receiver while the vehicle is operating (in the run mode) and periodically when the vehicle is off. The GPS data is stored temporarily in system scratch pad memory and is routinely updated. Also continuously monitored, by means of an onboard multiple axis accelerometer cluster, is shock and vibration data. This occurs while the vehicle is in the run mode and periodically when the vehicle is at rest. The system compares the shock and vibration data to preprogrammed limits.

The system will determine that a non-standard event has occurred when it detects that the vehicle has been moved without a proper ignition start, or when the onboard alarm triggers a break in. A non-standard event is also triggered when the signals from the accelerometer exceed a certain preprogrammed limit. When such an event is detected by the system, the pertinent data is transmitted through the telecommunication transceiver system (modem) to a receiving station monitoring the vehicle's particular operational frequency and encoded data message. In the case of a collision having been recorded, the system will transmit the collision force (acceleration +ve or −ve) details as well as the last fix to the Monitoring Centre.

If a tracking request is made to the system, the system will continuously transmit the fix of the vehicle to a Monitoring Centre. This allows the vehicle to be tracked by the authorities. The system will continuously transmit updated fixes until another special signal is received from the Monitoring Centre instructing the system to terminate its transmissions. This will occur when the vehicle has been located.

Although the main function of the VLD is to notify emergency services in the event of an accident or theft, there are several other uses that can be defined. Some other features are as follows:

Collision Detection:

The installed system will detect a collision involving the vehicle. This would be useful in the event that the vehicle was hit or involved in some sort of accident while the driver or owner was not present, i.e. parked in a lot or on the street.

The VLD uses onboard sensors as well as the vehicle's own sensors to determine occurrence and seriousness of the collision. Typical crash force/time signatures and or maximum acceleration forces would be programmed into the memory of the MCM. If the accelerometer output matches or exceeds one of these signatures or forces, the VLD will determine the severity and then initiate its transmit mode.

The VLD Collision Detect sensors include:
Accelerometers—two or more sensors are used for the x and y axis.
Compass or Gyro—detects and reports lateral direction changes.
GPS—reports position of the receiver at defined intervals. From this data, speed and direction can be determined. (GPS and Compass data or compared with a GPS fix having priority).

The vehicle sensors which may be used by the VLD of the present invention include:
Air bag sensor—notifies the system that the air bag has been deployed.
Alarm—triggers system when car alarm is triggered.
   Automatic Notification of Collision:

This is useful for in case the occupant or driver was not able to conveniently notify authorities, either because they were injured or trapped, or even if there was no telephone in the area. The owner may or may not be injured.

When a collision has been detected the VLD system will immediately compose and send out the available accident data. An onboard RF modem will send the signal to a monitoring station. It is the monitoring station that will dispatch the required response team, police, ambulance, fire rescue or tow truck. The VLD shall continue to communicate the message at preset time intervals until acknowledgement message is received from the monitoring station.

Some of the parameters in the message may include:
Vehicle ID.
Location of the vehicle.
Time at which the collision occurred.
Air Bag status.
Impact force.
Speed prior to the collision.
Notification if a rollover occurred or not
Passenger in front seat?.
   Event Reconstruction:

This feature may be useful in police or insurance claim investigations, and or academic accident studies, when this data may assist agencies in reconstructing the accident with vehicle data.

The VLD onboard NVM (Non Volatile Memory) will electronically store the data from the sensors. In the event of a collision the data leading up to, during and a short interval after is stored in memory.

Theft Detection:

This feature is useful as a car alarm.

The system is capable of detecting a break-in and/or vehicle theft. The VLD uses onboard sensors in conjunction with the vehicle's own alarm sensors to determine that the vehicle has been broken into or stolen. The VLD sensors used to detect this include:
Accelerometers—used to detect motion of the vehicle even if the ignition is off. e.g. Vehicle is being towed or moved.
Compass or Gyro—used to detect direction changes if the vehicle is being moved.
GPS—used to detect location changes if the vehicle is being moved.

Vehicle's sensors which may be used by the VLD for theft detection include:
Vehicles own alarm system—if triggered the VLD automatically will send a vehicle theft message.

Location Reporting:

This very important feature allows a monitoring station to locate the vehicle at any time and to receive constantly updated position and condition reports from the vehicle.

A current position report (Tracking) can be sent if requested by the Monitoring Centre. The information may include geographical position, speed, bearing, time, date, and possibly if it was involved in a collision during the tracking session.

Self Status Reporting:

The system of the present invention periodically performs a self diagnostic check to determine if any failure modes had occurred. A status report is relayed via modem to the monitoring centre. If any failures are detected the owner will be notified to have the unit checked.

Assistance on Request:

This is useful if the owner or operator of the vehicle requires assistance, but is not aware of their exact location, such as in the middle of a uninhabited country road or desert highway.

The vehicle operator is able to call into the VLD system using a SMS (Short Messaging System) compliant cellular phone. This will send a message with an embedded code to request assistance. The system utilises SMS in order to access the preprogrammed options. The system will send out a message which includes vehicle location to the monitoring station. Requested assistance can then be dispatched from the nearest location.

System Disable on Request:

The system can be disabled to avoid any false alarms such as if the vehicle is being serviced. This is referred to as “Sleep Mode”. The owner can notify the monitoring station to disable the system. A message is sent from the station to the VLD's satellite modem. The system is automatically turned off for the amount of time specified in the message, or until another message is sent to reactivate the VLD.

Message Validation:

For every message VLD sends out to the Monitoring Centre it receives an acknowledgement that the message was received correctly. If no acknowledgement is received within a defined amount of time, the message will be resent. When acknowledgement is received by the VLD confirming a successful reception of the message by the monitoring station, the system will store that acknowledgement in its memory.

In a broad aspect, then, the present invention relates to a method of determining the location and status of a subject upon the occurence of a trigger event comprising: 1) activating a sensor to a predetermined level corresponding to a class of event upon the occurence of an event; 2) transmitting an event signal to a central station indicating the class of event; 3) monitoring for acknowledgement of receipt of signal; 4) receiving acknowledgement signal, or retransmitting event signal; 5) upon receipt of acknowledgement signal, entering a monitor mode.

In drawings that illustrate the present invention, and its components:

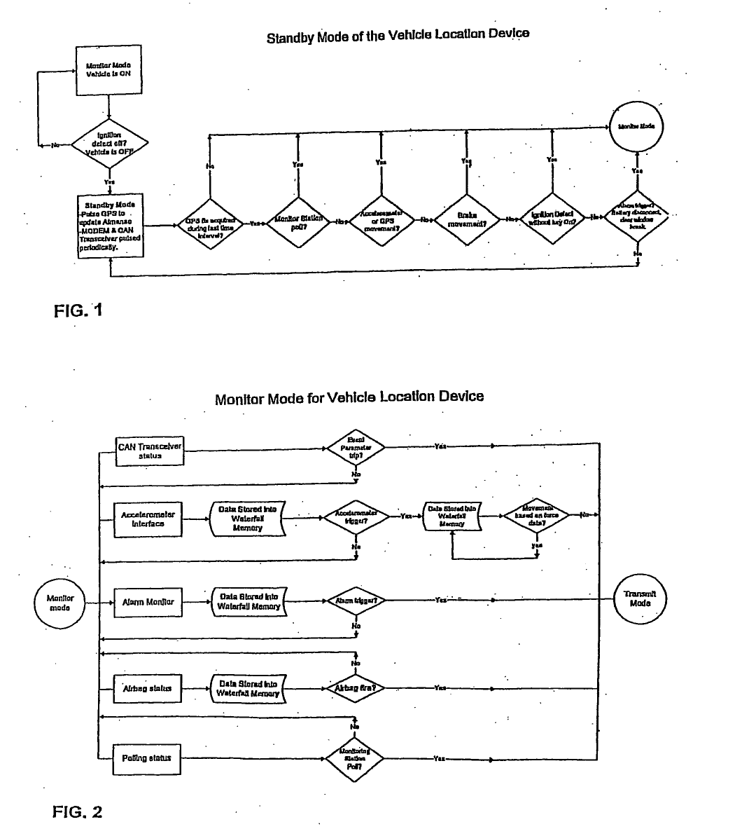

FIG. 1 is a chart illustrating the standby mode of operator of the present invention.

FIG. 2 is a chart illustrating monitor mode for the VLD of the present invention.

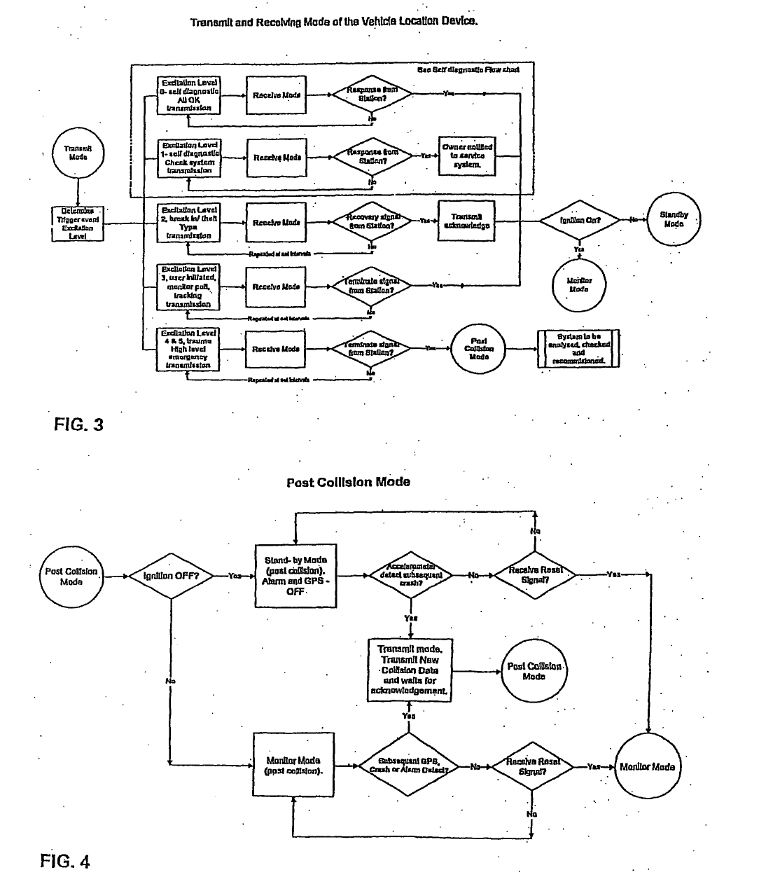

FIG. 3 is a chart illustrating transmit & receiving mode of the VLD of the present invention.

FIG. 4 is a chart illustrating post collision mode of the VLD of the present invention.

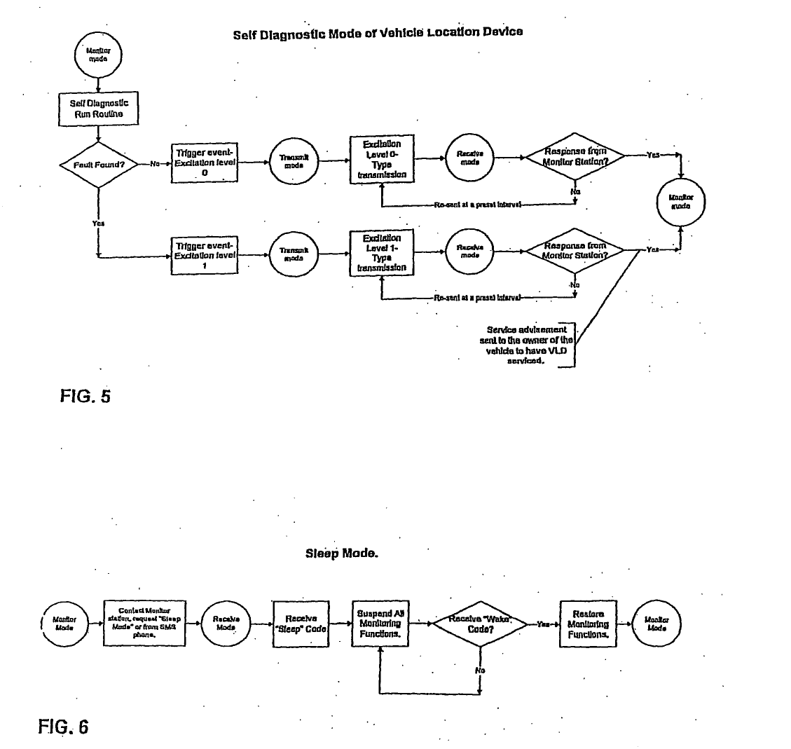

FIG. 5 is a chart illustrating self diagnostic mode of the VLD of the present invention.

FIG. 6 is a chart illustrating sleep mode of the VLD of the present invention.

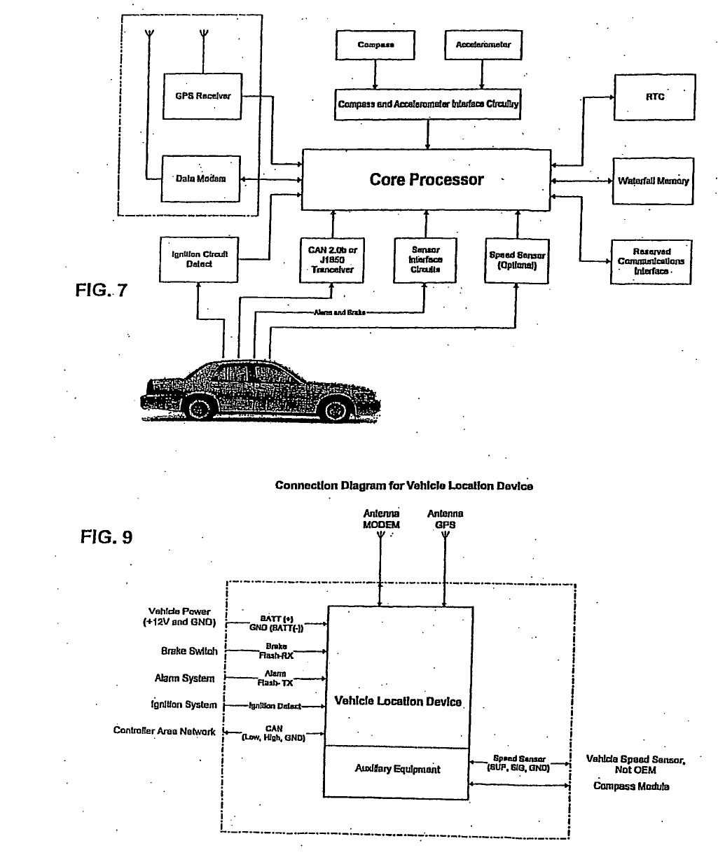

FIG. 7 is a chart illustrating the system architecture of the VLD of the present invention.

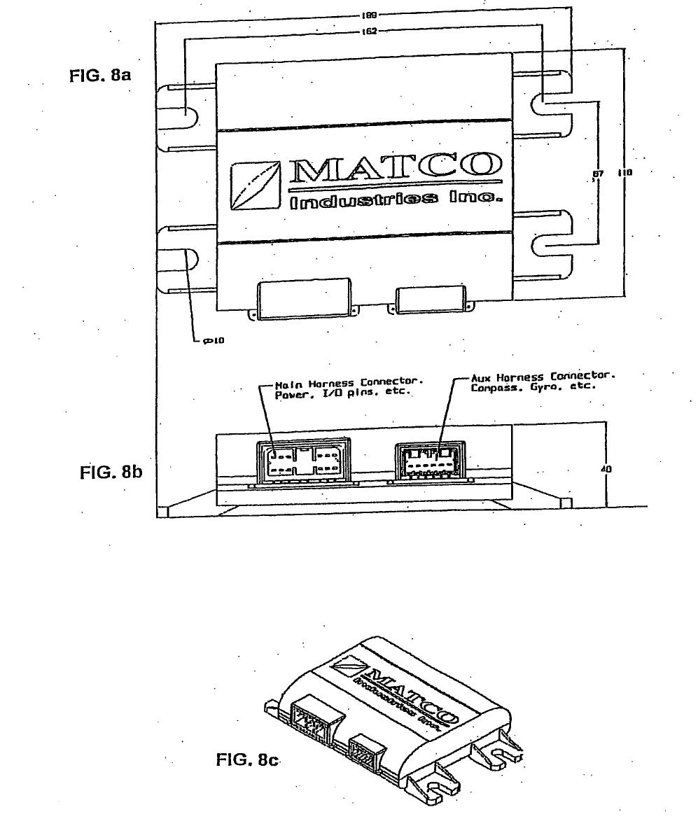

FIGS. 8a, 8b and 8c are top, end and perspective views of a bare unit according to the present invention.

FIG. 9 is a connection diagram for the VLD of the present invention.

### MODES OF OPERATION

The VLD system will constantly monitor the status of the sensors. Depending on the status of the vehicle, ignition on or off, the VLD will enter and maintain different monitor modes.

Standby Mode:

The standby mode, illustrated in FIG. 1, is the state of the VLD when the ignition is off and the vehicle is at rest. The VLD will enter the standby mode when the ignition detect circuit determines that the ignition is turned off. In the standby mode, the VLD turns off certain modules to conserve power and then will selectively monitor the status of others. In this mode the MCU (Micro Controller Unit) will send a pulse signal to the GPS module at set time intervals. The GPS module will then reacquire its almanac (update its position and time data) if possible. If the GPS cannot acquire a good signal the last known fix is retained in memory. If the system cannot acquire a fix or signal from the GPS module after a predetermined length of time (days or weeks), the system will enter the Monitor Mode.

The system will activate the modem at periodic intervals. This allows the modem to scan its “mailbox” to see if there are any special instructions waiting. If there are any special instructions, such as a poll to send its current position, the system will enter the Monitor Mode.

The system will also pulse the accelerometer cluster every second. The accelerometers will detect any movement of the car that imposes a force over time greater than a preprogrammed threshold rate. If the accelerometer interface is triggered, the car enters into the Monitor Mode.

An activation of the car alarm will automatically trigger the VLD into the Monitor Mode. A polling signal from the monitoring station will trigger the VLD into the Monitor Mode.

Power consumption during Standby Mode is minimal.

Monitor Mode:

When the vehicle's ignition is turned on, or when any activity on the monitored sensors is detected, the system will enter the Monitor Mode as shown in FIG. 2. In this mode the system will constantly scan the onboard sensors as well as the vehicle's sensors for data patterns that would be indicative of a collision or theft. Events of this nature are referred to as trigger events. All data collected during the Monitor Mode is stored in the waterfall memory (oldest data is pushed out by the newest being recorded). The sensors being monitored include the Global Positioning System, accelerometer cluster (X and Y axis), air bag status sensor, and vehicle's own alarm system.

In the event of a collision trigger event, the system will continue to record the sensor data from its sensors until it is determined that the event has ended based on the accelerometer data. When the accelerometer register a null delta acceleration, it will conclude that the vehicle has come to rest. The VLD will then enter the Transmit Mode.

Transmit Mode:

Immediately after the system detects a trigger event, it will enter the Transmit Mode. When in this mode, the system will attempt to transmit a message to the Monitoring Centre.

The message transmitted by the VLD will be structured depending upon the nature of the trigger event. The different structures of the messages as shown in Table 1 will establish the urgency or excitation level of the trigger event—a break-in message is a lower excitation level than that of a collision/airbag trigger event.

TABLE 1

| | Excitation | |
|---|---|---|
| Trigger Event | Level | Aftermath Process |
| System Check- No fault | Excitation | No report |
| | Level 0 | |
| System Check- Fault | Excitation | Owner is notified to check system |
| | Level 1 | |
| Break In | Excitation | Police, owner notified, start track. |
| | Level 2 | |
| Tow away alert | Excitation | Police, owner notified, start track. |
| | Level 2 | |
| User, Monitor request, | Excitation | Start track, report fix at set |
| Poll | Level 3 | intervals |
| Collision | Excitation | Police, emergency agency alerted. |
| | Level 4 | |
| Collision + Airbag | Excitation | Police, emergency agency alerted. |
| | Level 5 | |
| Collision + | Excitation | Police, emergency agency alerted. |
| Airbag + rollover | Level 5 | |

Excitation Level 0

The system will enter Transmit Mode in order to send self status report message after performing a Self Diagnostic. This has the lowest priority in the response stream. There is no immediate owner notification regarding the VLD system status.

Excitation Level 1

The system will enter Transmit Mode (see FIG. 3) in order to send self status report message after performing a Self Diagnostic and locating a Fault or Check system flag, the system will transmit vehicle location, ID code and Fault code. It will continue to transmit this data until the Monitoring Centre sends back an acknowledgement signal. This level has a low priority in the response stream, that is there is no emergency service notification although the owner will be quickly notified about the vehicle's VLD system status.

Excitation Level 2

If the system detects that a vehicle break-in has occurred, it will send an excitation level 2 type signal message to the Monitoring Centre. The message will contain location, vehicle ID and other data and is continuously repeated. This continues until the vehicle is recovered by the authorities and the recovery of the vehicle is reported to the Monitoring Centre. When a message notifying the VLD system of the vehicle recovery is received, the system will return an acknowledgement and exit the transmit mode.

Excitation Level 3

If a user contacts the vehicle VLD system using a SMS compliant cellphone, requesting a specific assistance from a list of predetermined options, the system will send that request to the Monitoring Centre. After receiving an appropriate acknowledgement from the centre, the system will exit the Transmit Mode. A polling request from the Monitoring Station is also answered with an Excitation Level 3 response.

This message will contain the trigger event excitation data as well as the precise position and the time of the event. The message is repeated at preset time intervals until an acknowledgement signal indicating a successful reception is received from the Monitoring Station. Once the acknowledgement is received the system will exit the transmit mode.

Excitation Level 4, and 5

This level has the highest priority and would indicate to the Monitoring Station that there is injury, loss of life or extensive property damage. This is based on the magnitude of the accelerometer signals, the presence of an airbag fire signal, etc. In this case, an ambulance and resuscitation team might be immediately dispatched as well as the police.

The signal which is transmitted by the VLD to the Monitoring Station will contain all information which is pertinent to the rapid location and recovery of accident victims. The exact details of the data contained within the transmission will be governed by the type of event or the excitation level and therefore allow the EMS units to more accurately assess what type of emergency is involved, such as a collision or rollover car. This transmission is repeated on set time interval. The set time interval is dependent upon the excitation level. The repeat interval is in the order of minutes for a higher excitation level than would be expected for a routine service excitation level 0 which may be in hours.

The repeat message for an excitation level 2 or 3 (theft or polling events) is broadcast in two waves. Initially, the VLD will send out a standard transmission. Upon receipt of the initial standard message, the monitoring station will respond with a special acknowledgement message. The VLD will then continue to broadcast a special locating data packet to allow the enforcement authorities the ability to track the device and hence, the automobile. This message terminates when the monitoring station broadcasts a “recovered” acknowledgement Table 2 is a representation of a generic data transmission.

TABLE 2

| Message Type | |
|---|---|
| (Excitation Level) | Describes Excitation Level of VLD Transmission |
| Module ID Number | VLD ID Number |
| Packet Length | Packet Length, including checksum staring with |
| | Byte 0 |
| Retry Count | Number of Times Packet has been resent |
| Date and Time | Date and Time Stamp of Transmission Data |
| Position | Latitude and Longitude Position of VLD from |
| | GPS in degrees and minutes |
| Data | Message Data length and contents will vary |
| | according to Message Type |
| Checksum | Checksum provides transmission Bit Error |
| | Detection |

After the VLD has transmitted the excitation code, the VLD will exit the transmit mode and enter the receive mode.

Receive Mode:

The system is in the Receive Mode whenever the VLD is powered. That is, the modem is constantly powered and is capable of receiving messages, unless it is in the transmit mode.

When in the receive mode, the type of signals it will expect to receive is messages from the user or the polling signals from the Monitor Centre, as well as acknowledgements to previously sent messages—whatever the excitation level.

When a message is received by the Monitoring Centre notifying it of a collision, an acknowledgement is returned to the VLD system confirming a successful reception. In order to receive this acknowledgement the modem of the VLD system enters the Receive Mode. Once the acknowledgement message is received it is stored in the system's memory permanently. The original message with the collision details is erased from teh system's memory since it has been recorded by the Monitoring Centre.

Once a vehicle has been recovered after a theft or a break-in, a special message confirming the recovery is sent from the Monitoring Centre to the system. Upon the receipt of the message an acknowledgement is sent back to the Monitor Centre.

The system will enter the Receive Mode when the user contacts the system using an SMS compliant phone in order to select a specific assistance or to initiate/deactivate Sleep Mode.

While in Transmit or Receive mode the VLD will remain in the mode it was in prior to reception or transmission.

Post Collision Mode:

After the vehicle has been involved in a collision and the Monitoring Centre has been successfully notified of the occurrence, the system will enter the Post Collision Mode, as illustrated in FIG. 4.

If the vehicle's ignition is off, the system enters stand by mode with the exception of the fact that it recognises the fact that the vehicle was involved in a collision. During this time the system will not send messages if it recognises that the vehicle's alarm is activated or the vehicle is being moved. The system will however send another message if it recognises another collision.

If the vehicle's ignition is still on the system remains in monitor mode with the exception of the fact that it recognises that the vehicle was involved in a collision.

The system will remain in Post Collision Mode until it receives a message reinstating it to normal operation.

Self Diagnostic Mode:

The VLD will enter the Self Diagnostic Mode, as shown in FIG. 5, at set time intervals in order to test the integrity of the system.

If no faults are discovered an appropriate message is sent to the Monitoring Centre. Upon receipt of this message the system is confirmed to be fully functional.

If the VLD determines that a fault is discovered, an appropriate message is sent to the Monitoring Centre. The user is then notified to bring the system in for maintenance.

If the system is unable to send the message at a scheduled time because cellular signal is blocked or the service is unavailable, it will store the message in the memory and send it at the next available opportunity. While the Monitoring Centre is expecting a report it will give a grace period (length to be determined) for the system to send the message. If the message is not received at the end of the grace period the user will be contacted by the Monitoring Centre to determine if the system is functioning properly. In the case of modem or antenna failure, the system will be unable to communicate with the Monitoring Centre and must be brought in for maintenance. The owner will be notified, similar as to when the Monitoring Centre does not receive a Standby Mode acknowledgement signal for a set period of time (days or weeks).

Sleep Mode:

In the event of vehicle maintenance, body repair, vehicle being towed etc. the user is able to contact the system using an SMS compliant phone to place the system into the sleep mode (FIG. 6) in order to avoid false alarms.

While in sleep mode most of the functionality of the system is suspended and power consumption is minimal. The modem will periodically scan its mailbox for any messages.

Once the vehicle and the system are ready for use, the user will send another message (“Wake” code) reactivating the system and restoring all functionality.

System Architecture:

The architecture of the in-vehicle VLD module is as illustrated in FIG. 7.

The system base module is composed of several functional blocks:
Control, with MCU
GPS module
Telecommunications modem
   Control

The control section of the VLD incorporates as its main component, the central microprocessor. The main function of this is to control and process input data from various sources and then output data to, and control various communication sections. This circuit contains the main control unit (MCU), memory, the Real time clock (RTC) as well as other components.

Central Microprocessor

The microprocessor is the central control for all the data inputs, internal processing, and output to either the modem or memory. The embedded software determines the exact operating parameters of the VLD system. The software is flash upgradeable through the communications interface.

Real-Time Clock

The Real-time Clock (RTC) is necessary to provide an accurate time-stamp of the incidents that are occurring when the vehicle is travelling. It will be interfaced to the MCU through a serial Inter-Integrated Circuit (I²C) bus that operates at the preset frequency (see Software Specification). This is usable for the RTC and both of the EEPROMs that are attached to the lines. The RTC will also generate a 1 Hz pulse wave form that the MCU will use to periodically wakeup. This is to reduce power consumption when the system is in Standby Mode. A 3V standby battery allows the RTC keep its time data even if it is disconnected from the main power supply.

Memory

The Electronically Erasable Programmable Memories (EEPROM or E²Prom) are used for the waterfall memory application. The memory contains a hardened core that allows for 1 million write-cycles and allows storage for 64 K bits. The E²Prom are used to collect data gathered from the various sensors several times a second and are based on a first in, first out (FIFO) methodology. These registers will stop recording after a Trigger Event (i.e. Accident) has occurred and will contain 10 seconds of sensory data that was gathered prior to the event that took place. This data may be utilised to aid in some form of accident reconstruction. The E²Proms will be interfaced through the I²C bus that is shared with the RTC.

Reserved Communications Interface

The Reserved Communications Interface (RCI) is primarily utilised by the manufacturer or a licensed facility that has the authority required to interact with the MCM. Among other uses, this port is used for upgrading software in the MCU's Flash Memory and downloading the contents of the E²Proms in case of accident reconstruction. The RCI utilises a full duplex serial wire interface that complies with the RS232C standard. There is an RS-232 level, RTS signal input that allows the MCU to enter in the Reserved Communications Interface Mode (RCIM) upon power up. This mode allows the technician to upload or download the required data utilising MATCO software provided for this purpose. The maximum baud rate possible is 76.8 K.

Accelerometers

The accelerometer array is mounted into the main housing on a PC board. Oriented coincidental to the long front and back axis of the vehicle, they are configured to detect changes in velocity in up to three orthogonal planes, X (forward and back) and Y, (side to side). Primitive Z—(up and down) data may be derived from the X, Y accelerometer data if a third primary Z accelerometer is not provided.

The accelerometers utilise an X-Y-Z configuration and have a limit of +/−40 G. They incorporate an analogue output with the upper and lower boundaries at 5V and 0V respectively. These ICs are used as inclinometers to detect a change of inclination and as accelerometers to detect changes in direction and abrupt negative acceleration. The inclinometer is used to detect if the vehicle is being towed or involved in a roll-over. The accelerometer function is used to detect collisions, movement and can provide data concerning centrifugal acceleration. This gives the MCU an indication of any changes in vehicle bearing that may have taken place.

External Power Source

The VLD shall be capable of operating from external power connected through the harness. The VLD shall operate from the following external source:
Vehicular power: From an input voltage range of 9 to 16V and 21 to 28 VDC.

The power supply for the Main Control Module (MCM) may be a 12V (9V-16V) or a 24V (21V-28V) battery power supply system. It is able to withstand the automotive transients as specified in the Society of Automotive Engineers (SAE) specification SAE J1113/11, without any malfunctions or anomalies. The auxiliary power supplies are controlled by the Micro Controller Unit (MCU) which can turn the regulators off and achieve a low micro ampere quiescent current. The main regulator is a low dropout voltage, low quiescent current, +5V regulator that cannot be shut down as it supplies the MCU and some of the peripheral electronics. The 5V level was dictated by the number of components that need to utilise this level of voltage to function properly. A number of low pass filters are incorporated into the power supply design to ensure that the power supply lines contain limited noise and negligible ripple voltages. These ripple voltages will be below the limitations imposed by the Control Board's Integrated Circuits (ICs) as failure to do so may result in erratic behaviour of the system.

The input current requirements are a sum of current needed from each of the components. The majority of the current will be drawn by the RF modem and the GPS. On average the GPS will use around 160 mA at a 5V level, which includes the antenna power. The RF modem will utilise up to 2 A-2.5 A in short micro or millisecond transmission bursts. In a scenario, when all the components are on, active and loaded the control module will consume a maximum current of
I_{max(with tx)}=2,780 A.
This maximum value is overrated as the transmission bursts last only micro to milliseconds and only a certain number of components are at their highest level of consumption at each time. The average current consumption is dependent on the number of transmissions that are deployed.
Ignition Detection

The ignition detection pin is connected to the ignition line of the host vehicle and is used to toggle between different system modes by the processor. In order to save battery power, the MCM will enter a power saving mode (Standby Mode), that turns off and pulses certain peripheral ICs once it recognises that the ignition line has been turned off. This allows for certain security features to be implemented such as Tow Away Alert, without the added current consumption. Ths signal line from the ignition can be very noisy and can fluctuate within the TTL logic levels.

The ignition detect circuitry will filter the incoming signal to distinguish the state of the line. If an alternate line is available that coincides with the ignition line, it will be used as a substitute.

Brake Application

The brake input senses a response from the output of the vehicle and as limited to a maximum of 70V. The input is utilised for system activation when in Standby mode, and it is also used to collect brake information for the waterfall memory in case of accident reconstruction.

Alarm System

The alarm input senses a response from the vehicle's alarm when it is triggered. It is limited to a maximum of 70V and is used to detect vehicle break-ins. This will trigger the VLD to immediately transmit the vehicle telemetry to the satellite array and repeat this message periodically until a signal is received by the modem from the ground station.

Controller Area Network

The Controller Area Network (CAN) input (also a J1850 input) is to procure all vital operating data about the vehicle from the data bus. This connection, if possible will provide the brake status, vehicle speed, engine RPM, airbag status, etc., without directly tapping into those systems, and possibly installing independent sensors.

The vehicle network interface can be composed of two different systems, one utilising a two-wire differential, and the other on a single wire system. The CAN bus system implemented in the VLD utilises a two wire system but there are occurrences where only a single CAN wire is implemented. The system implemented in the VLD, is a two wire differential SAE Class B CAN 2.0 A/B that can transmit up to speeds of 125 Kbps. It is a fault tolerant system, that is, it is able to operate on a single wire if there was a fault in the opposite wire. It is a Class B network, classified under the Body network, allowing access to all medium speed data packets such as instrumentation and emission information. The VLD will use the identifiers common in the headers of the data packets to distinguish between different types in information. The CAN node will receive all messages transmitted on the line and it will filter out the messages that are irrelevant to the function and operation of the VLD. At no time will the VLD's CAN node be transmitting any messages onto the CAN bus. For that reason it will not have to include any collision detect or resolution that is an integral part of the Bosch Standard. The bit-stream wave form present on the CAN bus is standardised and is specified under the CAN network Sections in ISO 11898, BOSCH CAN 2.0b specifications and SAE J1583, incorporated herein by reference.

The next available vehicle network that can be utilised by the VLD for vehicular information is SAE J1850 VPW. These wave forms are governed and specified by the SAE J1850 standard. All headers and addressing have been assigned by SAE 2178 and can be easily used to access the information supplied by the vehicle. The physical interface requires that a time constant of 5 microseconds be maintained between all of the nodes. For that reason, the capacitance and resistance as seen by the bus will change according to the number of nodes on the vehicle in order to achieve the specification of the time constant. A simple hardware replacement can change the VLD's bus capacitance and resistance in order to meet the needs of the host vehicle.

GPS Module

The GPS module is an outside supplied unit. The function of this module is to provide the VLD function of determining the unit's geographical position with precision. The standard common accuracy of these units is dependent on a number of factors, both man made and natural. The common accuracy is typically ±10 m, 95% of the time. The GPS updates the position data at set time intervals.

The GPS module is a separate item that is installed inside the base module. It is directly interfaced to the Control circuit board.

The GPS system interfaces with the main control board through an internal wire harness. It receives the signal of the GPS satellites through a special antenna. The antenna is connected to the GPS module through the GPS antenna cable. There is to be no interconnection extension harness between the VLD and the antenna as this would degrade GPS performance.

The GPS receiver operates by calculating the range from the receiver to each satellite. Once the range to a satellite is determined, it follows that the receiver lies somewhere on a sphere with its radius equal to the calculated range. The position of the satellite is the centre of that sphere. If the range to a second satellite is found, a second sphere can be superimposed around the satellite. The receiver position now lies somewhere on the circle where the two spheres intersect.

This, it should be noted, is different than the circle of position concept in standard navigation terms as this circle is oriented with the centre axis ends coinciding with the position of the two satellites rather than the circle of position with a radius=90°−hₒ with its axis oriented between a celestial body and the geographical position of that body. With a third satellite, the sphere intercepting the circle results in two common points, the location is reduced to two points. A fourth satellite therefore faces the altitude of the receiver. To determine the range from to the satellite, the receiver requires two variables: elapse time and speed. A continuous radio signal sent out by the satellites, is picked up by the receiver which multiplies the speed of the signal by the time it took the signal to travel from the satellite to the receiver. The signal packet transmitted by the satellite is divided into a random sequence, each division being different from each other, called pseudo-random code (PRC). This random sequence is repeated continuously. The GPS receiver is programmed with this sequence and generates it internally. Therefore, satellites and the receivers must be synchronised. All GPS satellites have atomic clocks. The receiver picks up the satellite's transmission and compares the incoming signal to its own internal signal. A comparison of how much the satellite signal is lagging gives the travel elapse time, multiplication of this by the speed factor c=2.997 924 58×10⁶ m*s⁻¹, the official WGS-84 speed of light, determines the distance or range to that satellite.

GPS Sampling Rate

The MCM routinely accesses a GPS fix and stores it into memory. The rate of which the fix is accessed is proportional to the speed of the vehicle. That is, the fix sampling occurs less often when the vehicle is travelling at a slow rate of speed, and more often when the vehicle is travelling at a higher speed. The speed of the vehicle can be determined any number of ways, by GPS sampling, or from the vehicles own data bus, by external sensor or takeoff from the vehicle's instrumentation. The sampling rate or “Update Factor” relationship is illustrated in FIG. 3.

If the MCM experiences an acceleration (or deceleration) greater than a preset threshold (about 5 g's) over a maximum elapse time, the system will immediately try to acquire a fix from the GPS and store this to the NVM. In such a case the MCM is designed to aid in collision location. In addition to the location and time, the MCM can be additionally programmed to record the previous speed, time, course (direction) and other parameters over the past four samples.

The most recent fix is entered into the non-volatile memory (NVM) as FIX 1, indexing the preceding fix to FIX 2, the previous fix before that one to FIX 3 and so on. The previous FIX 4 is discarded. The NVM has the capacity to record four fixes, or the course of the receiver from four fixes back. Optionally, depending on programming, the MCM will estimate a Dead Reckoning (DR) position based on speed and bearing. This would be used if the GPS receiver was unable to acquire a usable fix: the antenna was shielded from satellites, or the unit suffered a power interruption and was performing a boot (warm) at the time.

The inverse sampling rate is a result of the fact that the interrogation routine runs on a fixed time base. There are several pickups or data inputs that have to be read on a routine basis. These would include the vehicle speed sensor (probably of the vehicle bus), the GPS module, the brake input, and the crash sensors or accelerometer(s). This routine is accomplished during a fixed time which is not varied. For instance, the time between data updates from the GPS could be 200 ms, no matter the velocity the vehicle is travelling at. Thus the faster the vehicle travels, the greater distance it will cover in 200 ms compared to if it was travelling 50% or 10% of that speed. Therefore, there is an inverse relationship between vehicle distance travelled per unit time (speed) and update rate.

The module can also be programmed to output (calculate) the receiver's speed, bearing, and time, either local or UTC. The speed can be calculated to be either Kilometres/hour, Statute miles/hour or Nautical miles/hour. The bearing can be programmed to be degrees from True or grid (Mercator) north.

RF Data Modem

The RF Data modem is off the shelf. The function of the modem is to handle the communications between the VLD installed vehicle and the ground based monitoring station. There are several modes of communication that can be used.

The RF modem is a separate module that is installed inside the base unit.

The RF modem interfaces with the main control board through an internal wire harness. The antenna for the RF modem is connected to the module through the RF data antenna cable. There is no interconnection extension harness between the VLD and the antenna.

Antennae

The communications and the GPS systems require antenna systems to operate. The antenna systems are two separate items for the two functions, that is the GPS antenna is specially designed and produced for GPS applications and the modem antenna is only suited for telecommunication applications. There are special series of RF modems that allow the antenna to be integral with GPS antennas, but this specification will assume separate units.

GPS Antenna

The GPS antenna is conventionally mounted to the vehicle in such a way that it has a clear “view” of the GPS satellite array. This may entail mounting to the rear window or parcel deck of an automobile or other such locations.

The antenna is connected to the GPS unit by an antenna cable.

RF Modem Antenna

The antenna for the modem is largely dictated by the mode of communication of the modem. That is if the modem was designed for Low Earth Orbit communication, the antenna would be specifically designed for that type of signal, and the mounting position of it would be equally and carefully selected.

Cellular type of modems are widely available suitable for different types of telecommunications modes. Depending on the locale of the system, a different telecom system may be employed than that of North America. Cellular modem antennas are again specially designed to suit those different modes.

The RF Modem antenna is conventionally mounted to the vehicle in such a way that it is not blocked or shielded from the receiver tower or satellites. This may entail mounting to the rear window or parcel deck of an automobile or other such locations.

The antenna is connected to the RF modem unit by an antenna cable.

The vehicle's DR (Dead Reckoning) position may be determined by compass bearing and speed, given the vehicle's last fix from GPS. Dead Reckoning is the process of estimating a position by advancing a known position using course, speed, time and distance travelled.

These techniques are useful if it is not possible for the GPS system to acquire a fix. To determine a position by dead reckoning it is necessary to precisely know the vehicle speed, bearing-(magnetic and local variation), and time elapse. Standard calculations can be performed to derive the DR position.

Speed Sensor

An auxiliary speed sensor is installed into a vehicle when it is impractical or inadvisable to gain the vehicle speed data from the OEM bus. This may be for a number of reasons, i.e., non standard data bus structure, no data bus (older vehicle), etc. The signal output of the sensor is a known number of pulses per metre, and when multiplied by the elapse time, the velocity, and distance can be computed.

The speed sensor consists of a supply voltage line of 12V, a ground return and a signal line. The pulses will be composed of a frequency that is proportional to the velocity and it will be mounted in such a way that does not hinder or cause any malfunctions to the operation of the existing vehicle sensors. The speed sensor interface adjusts for any noise that may coincide with the signal wave form, as well as providing an appropriate input signal for the MCU's Time Base Capture Input.

The speed sensor can output its pulse signal in the form of a square pulse train or a sinusoid signal. The sinusoidal output type of sensor can be selected because of its low cost and ready supply. The Hall effect type may be chosen for its ideal output signal which needs minimal processing by the MCM.

Compass Module

The Compass Module contains a 2-axis magneto-resistive sensor that is located outside the MCM and in a location where it can easily detect the presence of magnetic north. The Accelerometer Module is contained within the box and is designed in a 2-axis configuration. The magneto-resistive sensors and the accelerometers coincide together to act as a compass if the GPS signal is lost. The data from both units are correlated with the speed sensor to calculate a position using recorded distance and direction data which is otherwise know as dead reckoning. The accelerometers can be pulsed at a minimum time equal to that of the settling time of the accelerometers plus the conversion rate of the MCU. This time converted to frequency is equal to approximately 900 kHz. The VLD operates at a slightly lower frequency to ensure that the data received is accurate. This allows for lower current consumption and battery drain when the module is in Standby Mode.

This information is correlated with the compass information to offset any errors caused by errant soft iron magnetic fields that are consistently changing. The 2-axis magneto-resistive (MR) sensor is composed of two resistive bridges that sense magnetic fields including magnetic north. The analogue outputs of the IC are amplified and filtered so that the MCU's Analogue to Digital Convertor (ADC) can interpret an accurate value. Hard Iron fields are magnetic fields that are constant and can be offset by software or hardware. The VLD is configured so that it recognises any hard iron error field and offsets it through the MCM software. The magnetic-resistive sensor is configured through hardware and software so that temperature and drift of the IC can be controlled. This results to increased repeatability and higher accuracy. The accuracy of the compass is dependent on the location of the module as strong stray magnetic fields from the surrounding environment will degrade the performance. These errors are dependent on the vehicle and the location in the vehicle. The magneto-resistive sensor's 5V power supply is also pulsed to reduce power consumption in the VLD's Standby Mode. The minimum time at which the MCU can pulse the compass is equal to the MR sensors settling time plus the conversion time of the MCU. This value converted to frequency is approximately 1.9 kHz. The VLD operates at a frequency slightly below this preset value.

Gyroscopic Modules

The position may also be determined using the last known fix and gyro unit. The characteristic of a gyro is its ability to maintain a position relative to earth regardless of the frame position. These modules put out signals from which the difference between last known bearing and current bearing can be derived. Thus the gyro allows the unit to determine changes in relative bearing rather than the compass which outputs magnetic bearings.

The gyro unit is not susceptible to magnetic variation and deviation as caused by the geographical location of the vehicle or outside sources.

The gyro module is a commercially available patented item available from several sources.

Construction

Item Description

The standard VLD system shall be comprised of a main base module, connecting harness(es), and antenna assembly.

The main base module shown in FIGS. 8a, 8b and 8c is securely installed into the vehicle in such a fashion that it may not loosen or twist out of position. It is housed in a plastic or plasticimetal enclosure. The main module is installed in an inconspicuous place in the car where it cannot be easily tampered with, or inadvertently damaged by other objects or equipment.

The connecting harness is connected to various points in the car such as power (+12V) ground, brake input, etc. The harness is connected into the main base module.

The antenna assembly(ies) are attached to the automobile such that they will normally have a clear and unrestricted “path” to the appropriate satellite array.

Enclosure

The enclosure of the MCM contains the main circuit board and the plugged on daughter boards (GPS receiver and the modem). The enclosure is a plastic moulded assembly consisting of a top and bottom half with optional side inserts for various connector configurations.

The bottom half is characterised by the protrusion of several reinforced mounting tabs or feet and/or various through holes for screw mounting to the vehicle. Moulded inside the bottom half is mounting bosses and guides for securing the circuit boards. Reinforcing ribs are also integral to the bottom half for stiffness and strength. The tray is designed to accommodate a layer of conformal coating and/or encapsulation if necessary.

The top half of the enclosure is moulded to complement the bottom half and to be mechanically secured to the bottom. Reinforcing ribs and structures provide strength and stiffness, and support for the daughter boards, connectors and auxiliary equipment. After assembling the enclosure together, the housing is a very stiff and secure enclosure.

The plastic material used will be an engineering thermoplastic with up to a 20% glass content. This maximum amount of glass content is to facilitated ultrasonic welding if that is the selected mode of assembly. More glass content will tend to impede the ultrasonic welding processes.

The enclosure is assembled using a variety of mechanical assembly methods. The PCB and components will be secured to the enclosure with screws, and the enclosure halves may be joined ultrasonically.

Interfaces

Connections and Signal Interfaces

Main Connector

The primary electrical connection to the main base module is through connector C1. C1 is a 14 pin shrouded locking header connector. The connector is directly attached to the main circuit board via locking pins and through electrical connection. The locking mechanism shall be such that it will not unlock and allow electrical disconnection through specified shock and vibration.

The Main Harness

The main harness plug C2 is plugged into C1. The main harness is connected to various points in the electrical system of the car. These points include:

1. Power

2. Ignition Detection

3. Brake application

4. Alarm

5. CAN (High, Low and ground)

Power Connections

The power inputs shall be as follows:

BATT(+) (2×)

BATT(−) Ground (2×)

These power inputs are connections to the vehicle's systems. The connections to these systems are through the main harness and the power extension harness. A second ground is supplied to the VLD from a single ground wire integral to the main harness. This line will not have a power extension harness mate.

BATT(+)

Power supply is from a main power feed (BATT (+)) that is not switched off when the ignition and/or accessories are turned off. This power circuit should not be part of any vital systems in the vehicle such as headlamp, alarm, ignition etc. or any circuit branches that are subject to high loads, impulses or excessive electronic noise. The voltage should stay relatively constant through the normal operation of the vehicle.

BATT (−) Ground

The two BATT (−) or ground connections shall be connected to the same point in the vehicle to avoid ground loops.

Ignition Detection Connection

The connection to the ignition circuit of the automobile is through the main harness and the power extension harness. A single wire tap is provided for connection to this circuit. The ignition sense line is connected to a line in the vehicle that is hot when running or with accessory on. It shall be off when the ignition switch is in the off position.

Brake Detection Connection

The connection to the brake switch is through the main harness and the signal harness extension. The brake switch input is made to the brake switch in the car.

Alarm Detection Connection

The alarm input is connected to the VLD through the main harness and the signal harness extension. The connection of the alarm system input is made to an output signal from the alarm system.

Controller Area Network Connection

The CAN bus is connected to the VLD through the main harness and the CAN extension harness. The connector for the CAN interface is TBD.

The CAN interface is connected to the vehicle's OEM CAN data bus from a tap in the data bus harness.

RF Connections and Antennas

The antenna systems for the modem and the GPS modules connect to these parts via RF connectors and harness assemblies.

The antennas for the GPS and the Modem modules are conventional items. The configuration can be selected to suit various mounting configurations and positions.

There are several GPS antennas on the market that incorporate part or all of the actual GPS circuitry. These are known as active antennas and have the advantage in that the harness interconnecting the antenna to the main module is a data cable rather than a delicate RF coaxial cable. The RF cable is restrictive in that more than a few interconnections will degrade the signal of the GPS antenna and thus the sensitivity of the unit.

Small coaxial types of connectors are used to connect the RF cables to the GPS receiver module.

The Modem antenna is a small whip antenna that can be mounted in a variety of positions in or outside of the vehicle. It is connected to the main module through an RF coaxial cable.

Small coaxial types of connectors are used to connect the RF cables to the Modem module.

Speed Sensor

The speed sensor may be installed at a wheel position, it may be interfaced into a speedometer cable, or it may be integrated into the transmission housing, picking up the signal from the drive pinion gear. Those skilled in the art will recognise several more techniques normally employed to detect vehicle speed.

Dead Reckoning Module

The Dead Reckoning module is connected to the base module through an independent connector/harness. The unit is independent so that the connector may be blocked off when not utilised. If the DR module incorporates the compass technology, it will be installed into the vehicle where it is away from stray magnetic fields and influences of the vehicle's iron content as much as possible.

Gyro technology DR units are not restrictive as to mounting locations.

1) A method of determining the location and status of a subject upon the occurrence of a trigger event comprising:
1) activating a sensor to a predetermined level corresponding to a class of event upon the occurrence of an event;
2) transmitting an event signal to a central station indicating the class of event;
3) monitoring for acknowledgement of receipt of signal;
4) receiving acknowledgement signal, or retransmitting event signal;
5) upon receipt of acknowledgement signal, entering a monitor mode.

2) A method as claimed in claim 1, wherein said monitor mode comprises at least monitoring subject acceleration, and collision notification sensors.

3) A vehicle location device comprising a core processor equipped with a waterfall memory and a communication interface, sensors including a compass, an accelerometer, an ignition circuit sensor and a speed sensor, a GPS receiver and a data modem, wherein said data modem is adapted to transmit position and status information received from said GPS and said sensors, and said memory is adapted to store sensed data on a continuous basis for real time or delayed monitoring as desired.
